(19) United States
(12) Patent Application Publication
(10) Pub. No.: US 2017/0235588 A1
(43) Pub. Date: Aug. 17, 2017

(54) PROVISIONING OF VIRTUAL MACHINES WITH SECURITY REQUIREMENTS

(71) Applicant: INTELLECTUAL VENTURES HONG KONG LIMITED, Central (HK)

(72) Inventors: Jianping Wang, Kowloon Tong (HK); Wen Qi, Kowloon Tong (HK)

(73) Assignee: INTELLECTUAL VENTURES HONG KONG LIMITED, Central (HK)

(21) Appl. No.: 15/111,231

(22) PCT Filed: Sep. 15, 2015
(86) PCT No.: PCT/CN2015/089608

§ 371 Date: Jul. 13, 2016

(51) Int. Cl. G06F 9/455; H04L 29/06

(52) U.S. Cl. CPC G06F 9/45558; H04L 63/20; G06F 2009/4557; G06F 2009/45587; G06F 2009/45595

(57) ABSTRACT

Technologies are generally described to provision virtual machines with security requirements in datacenter. In some examples, a scheduler at a datacenter may receive a request to provision a virtual machine, where the virtual machine has an associated security requirement. Based on the security requirement, the scheduler may compute a maximum co-run probability of the virtual machine with at least one other virtual machine. The scheduler may then attempt to determine whether the virtual machine can be accommodated on an already-operational server while satisfying both the maximum co-run probability and a computing resource capacity associated with the virtual machine. If so, the virtual machine may be provisioned on the working server. Otherwise, the virtual machine may be provisioned on a new server if possible.

### BACKGROUND

Unless otherwise indicated herein, the materials described in this section are not prior art to the claims in this application and are not admitted to be prior art by inclusion in this section.

As cloud computing becomes more widely available, more and more businesses are using cloud services to implement their infrastructure. Because many cloud services use resource-sharing to achieve economies of scale, security is an ever-present issue. For example, a virtual machine (VM) implemented on a cloud service may be susceptible to cross-VM covert channel attacks that exploit shared physical resources.

### SUMMARY

The present disclosure generally describes techniques to provision virtual machines having security requirements.

According to some examples, a method is provided to provision a virtual machine having a security requirement. The method may include receiving a request to provision the virtual machine and determining, based on a security requirement, a maximum co-run probability of another virtual machine with the virtual machine. The method may further include determining a computing resource capacity associated with the virtual machine and identifying a server on which the virtual machine is to be provisioned based on the maximum co-run probability and the computing resource capacity.

According to other examples, a virtual machine manager (VMM) is provided to provision virtual machines having security requirements. The VMM may include a scheduler and a processor block. The scheduler may be configured to receive a request to provision a virtual machine associated with a security requirement and determine, based on the security requirement, a maximum co-run probability of another virtual machine with the virtual machine. The scheduler may be further configured to determine a computing resource capacity associated with the virtual machine and determine, based on the maximum co-run probability and the computing resource capacity, whether the virtual machine can be provisioned on a working server. The processor block may be configured to provision the virtual machine on the working server or cause the virtual machine to be provisioned on a new server.

According to further examples, a cloud-based datacenter is configured to provide cross-virtual-machine security. The datacenter may include at least one working server, a scheduler, and a datacenter controller. The working server(s) may be configured to execute one or more virtual machines. The scheduler may be configured to receive a request to provision a virtual machine associated with a security requirement and determine, based on the security requirement, a maximum co-run probability of another virtual machine with the virtual machine. The scheduler may be further configured to determine a computing resource capacity associated with the virtual machine and determine, based on the maximum co-run probability and the computing resource capacity, whether the virtual machine can be provisioned on the working server(s). The datacenter controller may be configured to provision the virtual machine on the working server(s) or start up a new server and provision the virtual machine on the new server.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example datacenter-based system where virtual machines may be provisioned with security requirements;

FIG. 2 illustrates an example system at a datacenter where virtual machines may be provisioned;

FIG. 3 depicts how scheduling may be used to reduce co-run probabilities among virtual machines;

FIG. 4 illustrates a general purpose computing device, which may be used to provision virtual machines having security requirements;

FIG. 5 is a flow diagram illustrating an example method to provision virtual machines having security requirements that may be performed by a computing device such as the computing device in FIG. 4; and

FIG. 6 illustrates a block diagram of an example computer program product,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to techniques to provision virtual machines with security requirements.

Briefly stated, technologies are generally described to provision virtual machines with security requirements in datacenters. In some examples, a scheduler at a datacenter may receive a request to provision a virtual machine, where the virtual machine has an associated security requirement. Based on the security requirement, the scheduler may compute a maximum co-run probability of the virtual machine with at least one other virtual machine. The scheduler may then attempt to determine whether the virtual machine can be accommodated on an already-operational server while satisfying both the maximum co-run probability and a computing resource capacity associated with the virtual machine. If so, the virtual machine may be provisioned on the working server. Otherwise, the virtual machine may be provisioned on a new server if possible.

A datacenter, as used herein, refers to an entity that hosts services and applications for customers through one or more physical server installations and one or more virtual machines executed in those server installations. Customers of the datacenter, also referred to as tenants, may be organizations that provide access to their services for multiple users. One example configuration may include an online retail service that provides retail sale services to consumers (users). The retail service may employ multiple applications (e.g., presentation of retail goods, purchase management, shipping management, inventory management, etc.), which may be hosted by one or more datacenters. Thus, a consumer may communicate with those applications of the retail service through a client application such as a browser over one or more networks and receive the provided service without realizing where the individual applications are actually executed. This scenario contrasts with configurations where each service provider would execute their applications and have their users access those applications on the retail service's own servers physically located on retail service premises.

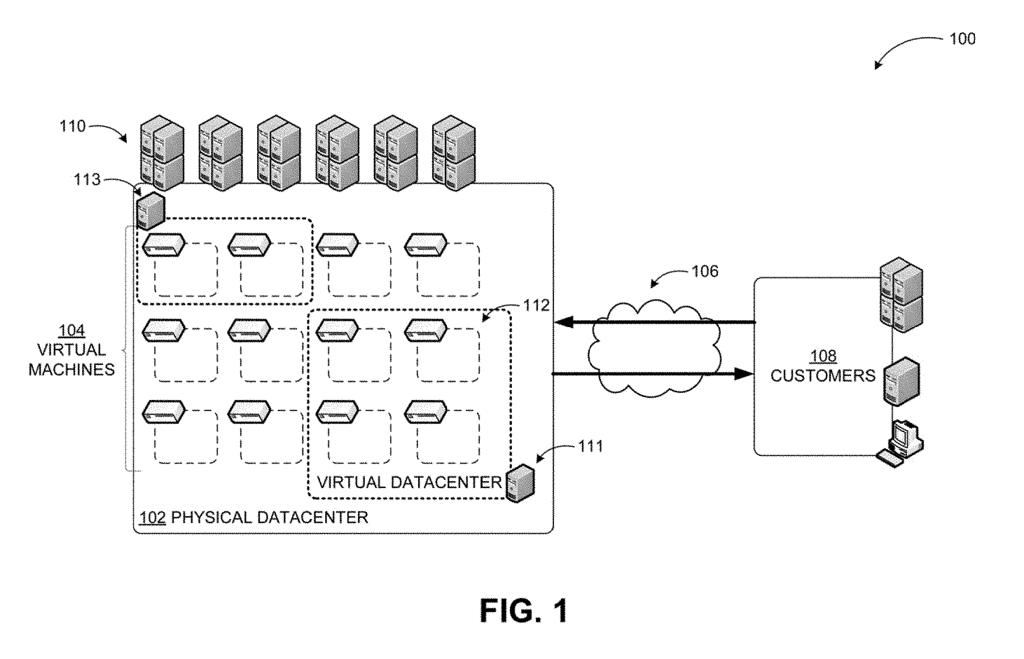

FIG. 1 illustrates an example datacenter-based system where virtual machines may be provisioned with security requirements, arranged in accordance with at least some embodiments described herein.

As shown in a diagram 100, a physical datacenter 102 may include one or more physical servers 110, 111, and 113, each of which may be configured to provide one or more virtual machines 104. For example, the physical servers 111 and 113 may be configured to provide four virtual machines and two virtual machines, respectively. In some embodiments, one or more virtual machines may be combined into one or more virtual datacenters. For example, the four virtual machines provided by the server 111 may be combined into a virtual datacenter 112. The virtual machines 104 and/or the virtual datacenter 112 may be configured to provide cloud-related data/computing services such as various applications, data storage, data processing, or comparable ones to a group of customers 108, such as individual users or enterprise customers, via a cloud 106.

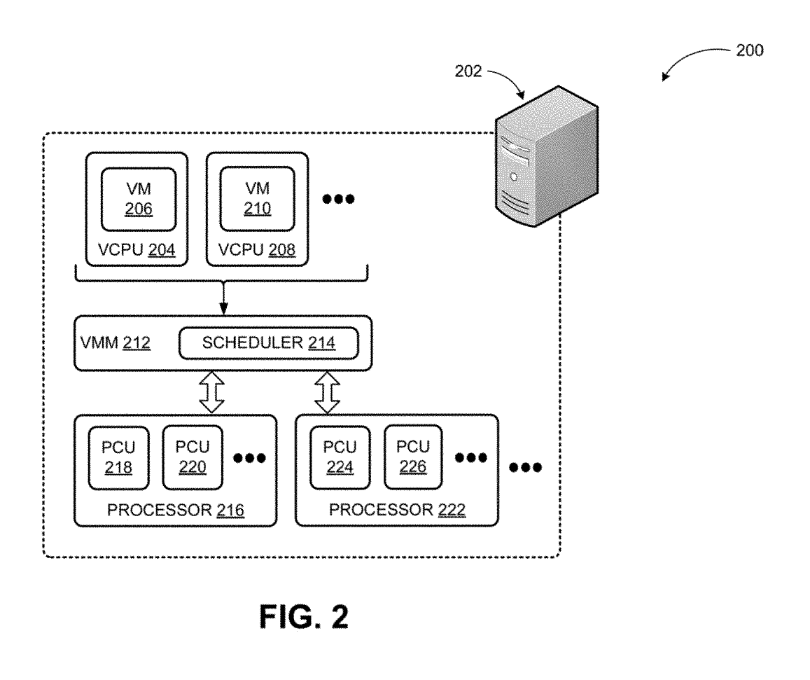

FIG. 2 illustrates an example system at a datacenter where virtual machines may be provisioned, arranged in accordance with at least some embodiments described herein.

As shown in a diagram 200, a physical server 202 (e.g., the physical servers 110, 111, or 113 in FIG. 1) may be configured with one or more processors, such as a processor 216 and a processor 222. In some embodiments, each processor may include one or more processor cores or physical computing units (PCUs). For example, the processor 216 may include a PCU 218 and a PCU 220, and the processor 222 may include a PCU 224 and a PCU 226.

A virtual machine manager (VMM) 212 implemented on the physical server 202 may be configured to cause a number of virtual machines (VMs), such as a first VM 206, a second VM 210, and optionally other VMs (not depicted), to be executed on the physical server 202. In some embodiments, the VMM 212 may be configured to allocate resources to the VMs executing on the physical server 202. For example, the VMM 212 may allocate processing capability from the PCUs 218, 220, 224, and 226 in the form of virtual central processing unit, or vCPUs. In the diagram 200, the VMM 212 may be configured to allocate processing capability in the form of a vCPU 204, a vCPU 208, and optionally other vCPUs (not depicted). Each vCPU may then execute a particular VM. For example, the vCPU 204 may execute the VM 206, while the vCPU 208 may execute the VM 210.

In some embodiments, the VMM 212 may allocate to each of the vCPUs the processing capability of a single PCU, of multiple PCUs, or a fraction of a single PCU. In addition, a scheduler 214 of the VMM 212 may be configured to vary the specific PCUs allocated to a particular vCPU over time. For example, the scheduler 214 may initially allocate the PCU 218 to the vCPU 204, and may subsequently allocate the PCU 226 to the vCPU 204. In some embodiments, the scheduler 214 may also be responsible to determine the particular VM a particular vCPU is to execute.

Datacenter systems may allow multiple VMs to be executed on shared hardware, such as the processors 216 and 222 shown in the diagram 200. However, such resource-sharing schemes may allow malicious VMs that are co-resident or executed on the same hardware to communicate with each other to facilitate attacks on other co-resident VMs. For example, a first malicious VM may deliberately modify the status of a shared hardware component at a first time, and a second malicious VM may be configured to monitor the status of the shared hardware component at a second, subsequent time. In this way, data may be passed between different VMs. Such communication channels may be known as timing-based cross-VM covert channels, and may not be easily detectable.

In some embodiments, timing-based cross-VM covert channels may be mitigated by reducing the probability that two (or more) potentially malicious VMs are simultaneously executed, known as the “co-run probability”. Through decrease of the co-run probability of potentially malicious VMs, the opportunity for communication via and the channel capacity of timing-based cross-VM covert channels may be reduced.

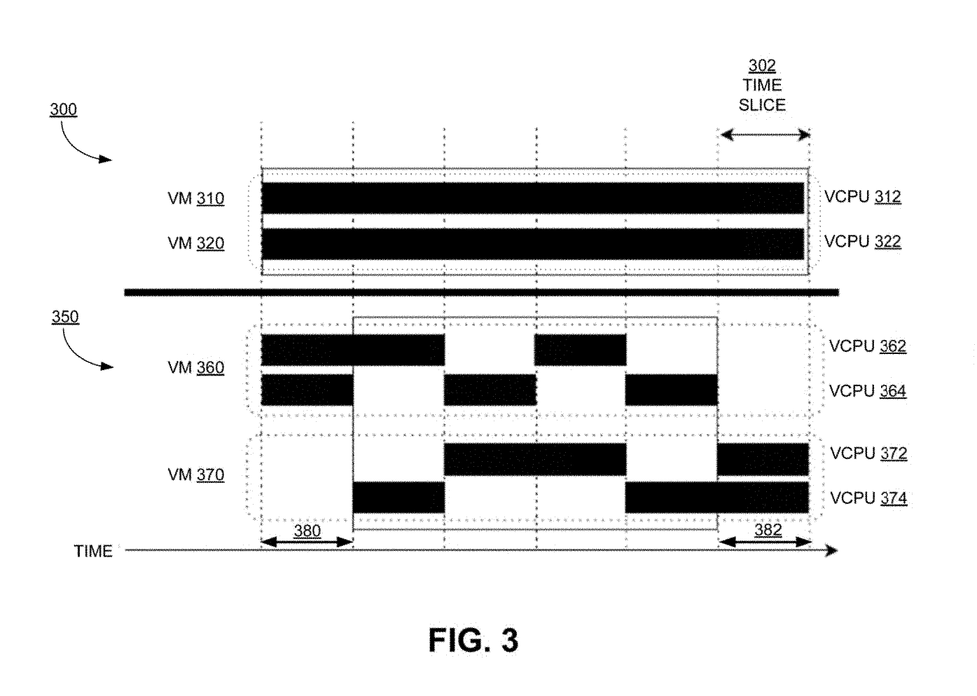

FIG. 3 depicts how scheduling may be used to reduce co-run probabilities among virtual machines, arranged in accordance with at least some embodiments described herein.

As shown in a diagram 300, a VMM such as the VMM 212 may provide a vCPU 312 and a vCPU 322. In some embodiments, the VMM may allocate an entire PCU, such as the PCUs 218, 220, 224, and 226, to each of the vCPUs 312 and 322. A scheduler, such as the scheduler 214, may then schedule a first VM 310 and a second VM 320 to execute on the first and second vCPUs 312 and 322, respectively. The scheduler may schedule the VMs to execute during a particular time period, which may be divided into a number of time slices, such as a time slice 302. The first VM 310 and the second VM 320 may both execute during the same time period, as indicated by the dotted box in the diagram 300. Accordingly, the co-run probability of the first VM 310 and the second VM 320 for the time period depicted in the diagram 300 is 100%, which may allow for substantial cross-VM covert channel communication.

In some embodiments, the VMM and the scheduler may be configured to distribute the execution of different VMs across different vCPUs in order to reduce the co-run probability of the different VMs. A diagram 350 depicts a situation similar to the one depicted in the diagram 300, where the scheduler schedules two VMs 360 and 370 on the equivalent of two PCUs. In contrast to the diagram 300, the VMM may provide four different vCPUs 362, 364, 372, and 374, and may allocate a fraction of a PCU to each vCPU instead of an entire PCU. For example, the VMM may allocate half of a PCU's processing time or capability to each of the vCPUs 362, 364, 372, and 374. In this situation, the scheduler may schedule a first VM 360 and a second VM 370 on the vCPUs 362, 364, 372, and 374 in order to reduce co-run probability while maintaining the overall processing time or capability provided to the first VM 360 and the second VM 370. For example, during a first time slice 380, the scheduler may schedule the first VM 360 to execute on the vCPUs 362 and 364 but not schedule the second VM 370 to execute on any vCPUs. During a second time slice 382, the scheduler may schedule the second VM 370 to execute on the vCPUs 372 and 374 but not schedule the first VM 360 to execute on any vCPUs. Accordingly, the co-run probability of the VM 360 and the VM 370 in the diagram 350 is 66%, reduced from the situation in the diagram 300. At the same time, the processing time or capability provided to each of the VMs 360 and 370 may remain similar to the situation in the diagram 300.

In some embodiments, the scheduler may schedule multiple VMs across multiple vCPUs to reduce co-run probability based on a system model and one or more scheduling algorithms. A system model may be developed based on a number of parameters. In some embodiments, system model parameters may include computing power and security level. Computing power may be defined as the PCU processing power allocated to a particular VM or vCPU. For example, for a server that is configured with m PCUs and n vCPUs, each vCPU may have a computing power of m/n PCUs. Security level is inversely proportional to the maximum co-run probability of a particular VM with any other VM. Accordingly, the higher the security level desired for a VM to be executed on a particular server, the lower the allowable maximum co-run probability of any two VMs on that server.

According to one model embodiment, every server may have the same number of PCUs, denoted as m, and each server may have a particular type, denoted as k. Different server types may have different security levels and/or computing power. For example, a server of type k may implement nₖ vCPUs. Accordingly, each vCPU may have a computing power cₖ defined as:

$${c}_{k} = \{ \begin{matrix}1 , & if {n}_{k} \leq m \\ \frac{m}{{n}_{k}} , & otherwise\end{matrix}$$

In addition, the co-run probability between two VMs vᵢ and vⱼ may be defined as:

$${p}_{ij} = {max}_{j = 1 , 2 … , j != i} ( {\sum }_{d = 2}^{m} {\sum }_{e = 1}^{d - 1} ( \begin{matrix}{n}_{ki} \\ e\end{matrix} ) \times ( \begin{matrix}{n}_{kj} \\ d - e\end{matrix} ) \times \frac{( \begin{matrix}2 \\ 2\end{matrix} ) \times ( \begin{matrix}{n}_{k} - 2 \\ m - 2\end{matrix} )}{( \begin{matrix}{n}_{k} \\ m\end{matrix} )} )$$

Based on the system model described above, a VMM (or a scheduler of the VMM) may be able to provision customer-requested VMs in a way that satisfies customer security requirements and computational requirements while reducing the number of working servers (in other words, servers that are already operational), thereby reducing energy consumption. In some embodiments, the VMM may perform the provisioning at particular scheduling points. Scheduling points may include a time at which the VMM receives a customer launch request to launch a VM instance and a time at which the VMM receives a customer destroy request to remove a VM instance. At these scheduling points, the VMM may allocate hardware resources for VM launching requests, migrate VMs between servers, and recycle hardware resources in response to VM instance removal.

As discussed above, the scheduler may provision the customer-requested VMs based on a scheduling algorithm. In some embodiments, the goal of the scheduling algorithm may be reduce energy consumption by allocating resources from working servers to provision VM requests rather than launching new servers.

In some embodiments, the scheduler may use an equal scheduling scheme to provision VMs. An equal scheduling scheme, in which each vCPU or VM is allocated equal processing power or time, may allow reduction of VM co-run probabilities. The scheduler may implement the equal scheduling scheme by dividing VM execution time durations into time slices, such as the time slice 302, where each time slice represents the processing power of a PCU for the duration of the time slice. The scheduler may then schedule VMs such that each VM has substantially the same number of time slices. In an equal scheduling scheme, the co-run probability P_{i,j} between any two VMs vᵢ and vⱼ executing on a server of type k may be:

$${P}_{i , j} = \frac{m ( m - 1 )}{{n}_{k} ( {n}_{k} - 1 )} ,$$

where the server has m PCUs and implements nₖ vCPUs.

In some embodiments, upon receiving a customer request to provision a particular VM having a particular security level requirement, the scheduler may first attempt to determine a server type for the customer-requested VM. The scheduler may attempt to determine the server type such that (a) the security level (or alternately, the maximum co-run probability) required by the customer for the VM is met and (b) sufficient computing power or hardware resources will be available for the customer-requested VM, with (c) minimal over-provisioning, where over-provisioning means that more hardware resources are allocated to the VM than required. For example, the scheduler may attempt to determine appropriate server types based on the equal scheduling scheme described above. In general, the scheduler may identify a number of different server types that satisfy these specifications, and in some embodiments the scheduler may select the server type that provides the maximum number of vCPUs.

Subsequently, the scheduler may attempt to identify working servers upon which the customer-requested VM can be provisioned. For example, the scheduler may test each working server to determine (a) whether the working server has a configuration similar to the server types previously determined. The scheduler may also determine whether the security levels and/or computational requirements of the VMs currently executing on that working server can all be met if the customer-requested VM is added to the working server. The scheduler may add working servers that satisfies these conditions to a queue. After testing all working servers, the scheduler may determine whether the queue is empty (in other words, the customer-requested VM cannot be provisioned on any working server). If this is the case, the scheduler may determine whether a new server should be launched for the customer-requested VM. In some embodiments, the scheduler may evaluate whether the new server should be launched based on an over-provisioning cost (that is, the extra cost associated with exceeding the resource requirement of the customer-requested VM) and/or a server launch cost (that is, the cost associated with launching a new server). The scheduler may evaluate these costs based on the execution time of the customer-requested VM. For example, the scheduler may determine an estimated virtual machine start time and/or an estimated virtual machine time duration. In some embodiments, the scheduler may determine these estimated time quantities based on prior history. For example, the scheduler may use a linear regression algorithm, a machine learning algorithm, and/or sliding window algorithm to perform the estimation.

On the other hand, if the queue is not empty, then the scheduler may attempt to provision the customer-requested VM on one of the working servers in the queue. In some embodiments, the scheduler may use one or more bin-packing computations, such as a first-fit-decreasing algorithm and/or a best-fit algorithm, to provision the customer-requested VM on an appropriate working server. In situations where VM migration between servers is allowed, the scheduler may use an energy-aware heuristic computation that attempts to fit VMs onto all available working servers.

While computing power or PCU processing power is used in the above description, in other embodiments other hardware resources may be considered by the heuristic algorithms described above, such as processor capacity, processor core availability, bandwidth capacity, memory capacity, and/or data storage capacity. These hardware resources may be collectively described as “computing resource capacities”.

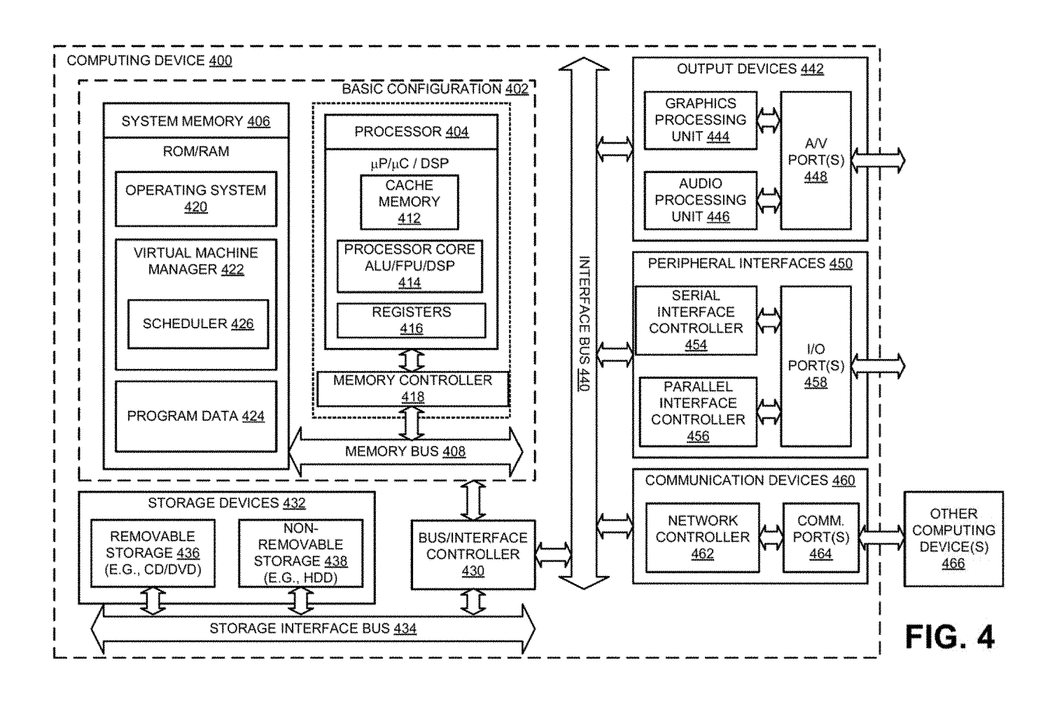

FIG. 4 illustrates a general purpose computing device, which may be used to provision virtual machines having security requirements, arranged in accordance with at least some embodiments described herein.

For example, the computing device 400 may be used to provision virtual machines having security requirements as described herein. In an example basic configuration 402, the computing device 400 may include one or more processors 404 and a system memory 406. A memory bus 408 may be used to communicate between the processor 404 and the system memory 406. The basic configuration 402 is illustrated in FIG. 4 by those components within the inner dashed line.

Depending on the desired configuration, the processor 404 may be of any type, including but not limited to a microprocessor (μP), a microcontroller (μC), a digital signal processor (DSP), or any combination thereof. The processor 404 may include one more levels of caching, such as a cache memory 412, a processor core 414, and registers 416. The example processor core 414 may include an arithmetic logic unit (ALU), a floating point unit (FPU), a digital signal processing core (DSP Core), or any combination thereof. An example memory controller 418 may also be used with the processor 404, or in some implementations, the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, a virtual machine manager 422, and program data 424. The virtual machine manager 422 may include a scheduler 426 to schedule virtual machine execution on virtual and/or physical processor units as described herein. The program data 424 may include data related to VM scheduling and other VM operations, for example.

The computing device 400 may have additional features or functionality, and additional interfaces to facilitate communications between the basic configuration 402 and any desired devices and interfaces. For example, a bus/interface controller 430 may be used to facilitate communications between the basic configuration 402 and one or more data storage devices 432 via a storage interface bus 434. The data storage devices 432 may be one or more removable storage devices 436, one or more non-removable storage devices 438, or a combination thereof. Examples of the removable storage and the non-removable storage devices include magnetic disk devices such as flexible disk drives and hard-disk drives (HDD), optical disk drives such as compact disc (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436 and the non-removable storage devices 438 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., one or more output devices 442, one or more peripheral interfaces 450, and one or more communication devices 460) to the basic configuration 402 via the bus/interface controller 430. Some of the example output devices 442 include a graphics processing unit 444 and an audio processing unit 446, which may be configured to communicate to various external devices such as a display or speakers via one or more A/V ports 448. One or more example peripheral interfaces 450 may include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 460 includes a network controller 462, which may be arranged to facilitate communications with one or more other computing devices 466 over a network communication link via one or more communication ports 464. The one or more other computing devices 466 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a part of a general purpose or specialized server, mainframe, or similar computer that includes any of the above functions. The computing device 400 may also be implemented as a personal computer including both laptop computer and non-laptop computer configurations.

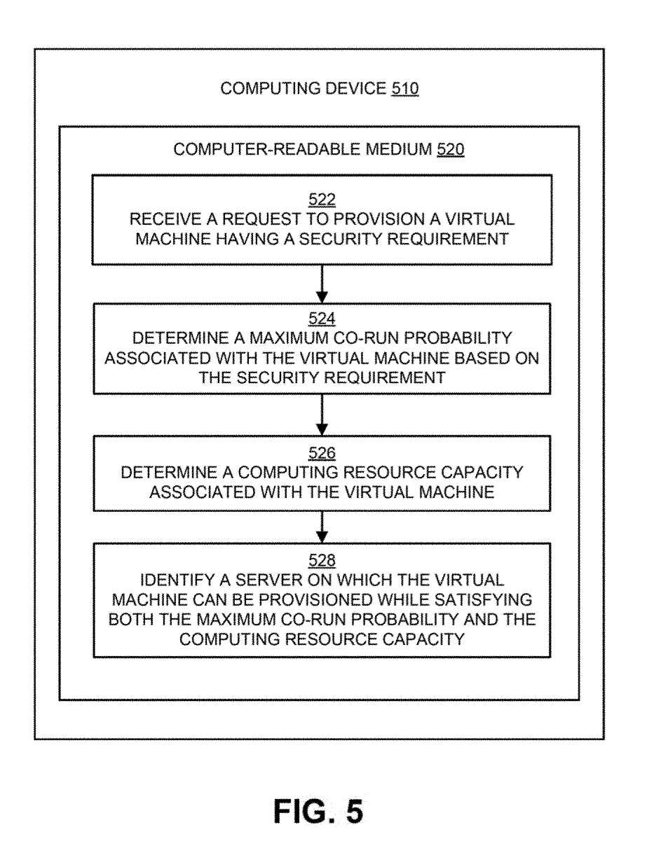

FIG. 5 is a flow diagram illustrating an example method to provision virtual machines having security requirements that may be performed by a computing device such as the computing device in FIG. 4, arranged in accordance with at least some embodiments described herein.

Example methods may include one or more operations, functions or actions as illustrated by one or more of blocks 522, 524, 526, and/or 528, and may in some embodiments be performed by a computing device such as the computing device 500 in FIG. 5. The operations described in the blocks 522-528 may also be stored as computer-executable instructions in a computer-readable medium such as a computer-readable medium 520 of a computing device 510.

An example process to provision virtual machines at a datacenter may begin with block 522, “RECEIVE A REQUEST TO PROVISION A VIRTUAL MACHINE HAVING A SECURITY REQUIREMENT”, where a virtual machine manager (for example, the VMM 212 or 422) may receive a customer request to launch a virtual machine instance. The virtual machine instance may have an associated computing power requirement and/or a security requirement, as described above. In some embodiments, the VMM may receive different security requirements for different instances of the same virtual machine, for example for execution on different types of servers or environments.

Block 522 may be followed by block 524, “DETERMINE A MAXIMUM CO-RUN PROBABILITY ASSOCIATED WITH THE VIRTUAL MACHINE BASED ON THE SECURITY REQUIREMENT”, where the VMM or a scheduler (for example, the scheduler 214 or 426) may use the security requirement associated with the VM to compute a maximum co-run probability, as described above. In some embodiments, co-run probability may be inversely proportional to the security requirement, and a maximum co-run probability may be required to satisfy a particular security requirement.

Block 524 may be followed by block 526, “DETERMINE A COMPUTING RESOURCE CAPACITY ASSOCIATED WITH THE VIRTUAL MACHINE”, where the VMM or scheduler may determine the hardware resources necessary to execute the customer-requested virtual machine, as described above. The computing resource capacity may include parameters associated with physical processors, but may also include a memory capacity, a bandwidth capacity, and/or a data storage capacity.

Block 526 may be followed by block 528, “IDENTIFY A SERVER ON WHICH THE VIRTUAL MACHINE CAN BE PROVISIONED WHILE SATISFYING BOTH THE MAXIMUM CO-RUN PROBABILITY AND THE COMPUTING RESOURCE CAPACITY”, where the VMM or scheduler may determine whether the customer-requested VM can be executed on an already-working server while satisfying the determined maximum co-run probability and the computing resource capacity of the VM, as described above. As part of the server identification, the VMM or scheduler may also determine whether co-run probability and computing resource capacity requirements for all VMs on a particular working server, including the customer-requested VM, can be satisfied. If not, the VMM or scheduler may launch a new server and provision the customer-requested VM on the new server, subject to evaluation of an over-provisioning and/or server launch cost.

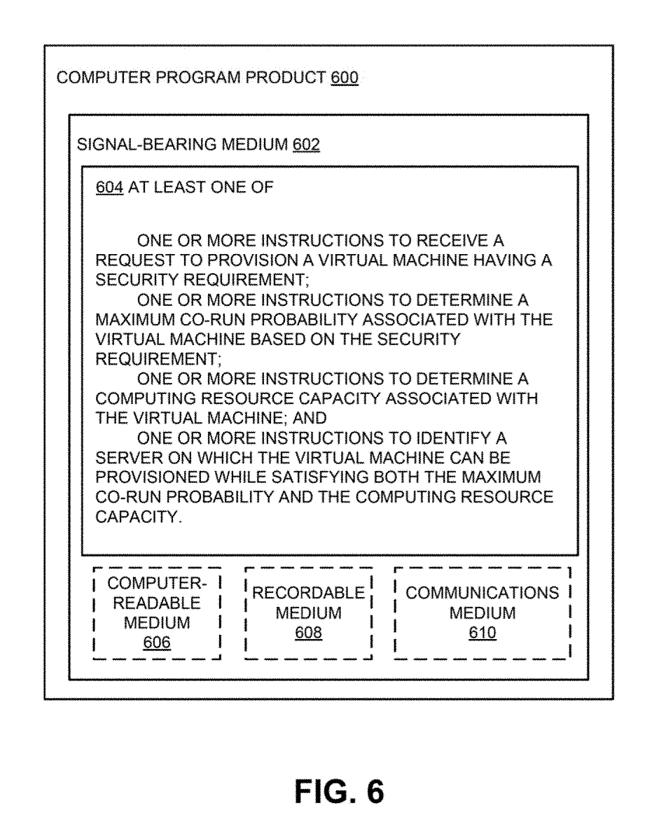

FIG. 6 illustrates a block diagram of an example computer program product, arranged in accordance with at least some embodiments described herein.

In some examples, as shown in FIG. 6, a computer program product 600 may include a signal bearing medium 602 that may also include one or more machine readable instructions 604 that, when executed by, for example, a processor may provide the functionality described herein. Thus, for example, referring to the processor 404 in FIG. 4, the virtual machine manager 422 may undertake one or more of the tasks shown in FIG. 6 in response to the instructions 604 conveyed to the processor 404 by the medium 602 to perform actions associated with provisioning virtual machines having security requirements as described herein. Some of those instructions may include, for example, instructions to receive a request to provision a virtual machine having a security requirement, determine a maximum co-run probability associated with the virtual machine based on the security requirement, determine a computing resource capacity associated with the virtual machine, and/or identify a server on which the virtual machine can be provisioned while satisfying both the maximum co-run probability and the computing resource capacity, according to some embodiments described herein.

In some implementations, the signal bearing media 602 depicted in FIG. 6 may encompass computer-readable media 606, such as, but not limited to, a hard disk drive, a solid state drive, a compact disc (CD), a digital versatile disk (DVD), a digital tape, memory, etc. In some implementations, the signal bearing media 602 may encompass recordable media 607, such as, but not limited to, memory, read/write (R/W) CDs, R/W DVDs, etc. In some implementations, the signal bearing media 602 may encompass communications media 610, such as, but not limited to, a digital and/or an analog communication medium (e.g., a fiber optic cable, a waveguide, a wired communications link, a wireless communication link, etc.). Thus, for example, the program product 600 may be conveyed to one or more modules of the processor 404 by an RF signal bearing medium, where the signal bearing media 602 is conveyed by the wireless communications media 610 (e.g., a wireless communications medium conforming with the IEEE 802.11 standard).

According to some examples, a method is provided to provision a virtual machine having a security requirement. The method may include receiving a request to provision the virtual machine and determining, based on a security requirement, a maximum co-run probability of another virtual machine with the virtual machine. The method may further include determining a computing resource capacity associated with the virtual machine and identifying a server on which the virtual machine is to be provisioned based on the maximum co-run probability and the computing resource capacity.

According to some embodiments, determining the maximum co-run probability may include determining the maximum co-run probability based on a number of virtual processing units available on the server. Identifying the server may include employing an equal scheduling scheme to identify the server. In some embodiments, identifying the server may include determining at least one server type that satisfies both the maximum co-run probability and the computing resource capacity and determining whether the server has a configuration similar to the determined at least one server type.

According to other embodiments, identifying the server may include launching a new server on which the virtual machine is to be provisioned and/or evaluating at least one of an over-provisioning cost and a server launch cost. Evaluating the over-provisioning cost and/or the server launch cost may include evaluating the over-provisioning cost and the server launch cost based on an estimated virtual machine start time and an estimated virtual machine time duration. The method may further include determining the estimated virtual machine start time and the estimated virtual machine time duration based on a linear regression estimation, a machine learning estimation, and/or a sliding window estimation. The method may further include provisioning the virtual machine on the identified server based on a bin-packing computation and/or an energy-aware heuristic computation.

According to other examples, a virtual machine manager (VMM) is provided to provision virtual machines having security requirements. The VMM may include a scheduler and a processor block. The scheduler may be configured to receive a request to provision a virtual machine associated with a security requirement and determine, based on the security requirement, a maximum co-run probability of another virtual machine with the virtual machine. The scheduler may be further configured to determine a computing resource capacity associated with the virtual machine and determine, based on the maximum co-run probability and the computing resource capacity, whether the virtual machine can be provisioned on a working server. The processor block may be configured to provision the virtual machine on the working server or cause the virtual machine to be provisioned on a new server.

According to some embodiments, the scheduler may be configured to determine the maximum co-run probability based on a number of virtual processing units available on the working server. The scheduler may be configured to determine whether the virtual machine can be provisioned on the working server based on an equal scheduling scheme. In some embodiments, the scheduler may be further configured to determine at least one server type that satisfies both the maximum co-run probability and the computing resource capacity and determine whether the working server has a configuration similar to the determined at least one server type.

According to other embodiments, the scheduler may be further configured to evaluate an over-provisioning cost and/or a server launch cost to determine whether the virtual machine can be provisioned on the working server. The scheduler may be configured to evaluate the over-provisioning cost and/or the server launch cost based on an estimated virtual machine start time and an estimated virtual machine time duration using a linear regression estimation, a machine learning estimation, and/or a sliding window estimation. The computing resource capacity may include a processor capacity, a processor core availability, a memory capacity, a bandwidth capacity, and/or a data storage capacity associated with the working server. The processor block may be configured to receive the security requirement for one or more instances of the virtual machine.

According to further examples, a cloud-based datacenter is configured to provide cross-virtual-machine security. The datacenter may include at least one working server, a scheduler, and a datacenter controller. The working server(s) may be configured to execute one or more virtual machines. The scheduler may be configured to receive a request to provision a virtual machine associated with a security requirement and determine, based on the security requirement, a maximum co-run probability of another virtual machine with the virtual machine. The scheduler may be further configured to determine a computing resource capacity associated with the virtual machine and determine, based on the maximum co-run probability and the computing resource capacity, whether the virtual machine can be provisioned on the working server(s). The datacenter controller may be configured to provision the virtual machine on the working server(s) or start up a new server and provision the virtual machine on the new server.

According to some embodiments, the scheduler may be configured to determine the maximum co-run probability based on a number of virtual processing units available on the at least one working server. The scheduler may be configured to determine whether the virtual machine can be provisioned on the at least one working server based on an equal scheduling scheme. In some embodiments, the scheduler may be further configured to determine at least one server type that satisfies both the maximum co-run probability and the computing resource capacity and determine whether the at least one working server has a configuration similar to the determined at least one server type.

According to other embodiments, the scheduler may be further configured to evaluate an over-provisioning cost and/or a server launch cost to determine whether the virtual machine can be provisioned on the at least one working server. The scheduler may be configured to evaluate the over-provisioning cost and the server launch cost based on an estimated virtual machine start time and an estimated virtual machine time duration. The scheduler may be further configured to determine the estimated virtual machine start time and the estimated virtual machine time duration based on a linear regression estimation, a machine learning estimation, and/or a sliding window estimation. The datacenter controller may be configured to receive the security requirement for one or more instances of the virtual machine.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a compact disc (CD), a digital versatile disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g.,” a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method to provision a virtual machine, the method comprising:
receiving a request to provision the virtual machine;
determining, based on a security requirement, a maximum co-run probability of another virtual machine with the virtual machine;
determining a computing resource capacity associated with the virtual machine; and
identifying a server on which the virtual machine is to be provisioned based on the maximum co-run probability and the computing resource capacity.

2. The method of claim 1, wherein determining the maximum co-run probability comprises determining the maximum co-run probability based on a number of virtual processing units available on the server.

3. The method of claim 1, wherein identifying the server comprises employing an equal scheduling scheme to identify the server.

4. The method of claim 1, wherein identifying the server comprises:
determining at least one server type that satisfies both the maximum co-run probability and the computing resource capacity; and
determining whether the server has a configuration similar to the determined at least one server type.

5. The method of claim 1, wherein identifying the server comprises launching a new server on which the virtual machine is to be provisioned.

6. The method of claim 5, wherein identifying the server further comprises evaluating at least one of an over-provisioning cost and a server launch cost.

7. The method of claim 6, wherein evaluating the at least one of the over-provisioning cost and the server launch cost comprises evaluating the over-provisioning cost and the server launch cost based on an estimated virtual machine start time and an estimated virtual machine time duration.

8. The method of claim 7, further comprising determining the estimated virtual machine start time and the estimated virtual machine time duration based on one or more of a linear regression estimation, a machine learning estimation, and a sliding window estimation.

9. The method of claim 1, further comprising provisioning the virtual machine on the identified server based on at least one of a bin-packing computation and an energy-aware heuristic computation.

10. A virtual machine manager (VMM) configured to provision virtual machines, the VMM comprising:
a scheduler configured to:
receive a request to provision a virtual machine associated with a security requirement;
determine, based on the security requirement, a maximum co-run probability of another virtual machine with the virtual machine;
determine a computing resource capacity associated with the virtual machine; and
determine, based on the maximum co-run probability and the computing resource capacity, whether the virtual machine can be provisioned on a working server; and
a processor block configured to provision the virtual machine on the working server or cause the virtual machine to be provisioned on a new server.

11. The VMM of claim 10, wherein the scheduler is configured to determine the maximum co-run probability based on a number of virtual processing units available on the working server.

12. The VMM of claim 10, wherein the scheduler is configured to determine whether the virtual machine can be provisioned on the working server based on an equal scheduling scheme.

13. The VMM of claim 10, wherein the scheduler is further configured to:
determine at least one server type that satisfies both the maximum co-run probability and the computing resource capacity; and
determine whether the working server has a configuration similar to the determined at least one server type.

14. The VMM of claim 10, wherein the scheduler is further configured to evaluate at least one of an over-provisioning cost and a server launch cost to determine whether the virtual machine can be provisioned on the working server.

15. The VMM of claim 14, wherein the scheduler is configured to evaluate the over-provisioning cost and the server launch cost based on an estimated virtual machine start time and an estimated virtual machine time duration using one or more of a linear regression estimation, a machine learning estimation, and a sliding window estimation.

16. The VMM of claim 10, wherein the computing resource capacity includes one or more of a processor capacity, a processor core availability, a memory capacity, a bandwidth capacity, and a data storage capacity associated with the working server.

17. The VMM of claim 10, wherein the processor block is configured to receive the security requirement for one or more instances of the virtual machine.

18. A cloud-based datacenter configured to provide cross-virtual-machine security, the datacenter comprising:
at least one working server configured to execute one or more virtual machines;
a scheduler configured to:
receive a request to provision a virtual machine associated with a security requirement;
determine, based on the security requirement, a maximum co-run probability of another virtual machine with the virtual machine;
determine a computing resource capacity associated with the virtual machine; and
determine, based on the maximum co-run probability and the computing resource capacity, whether the virtual machine can be provisioned on the at least one working server; and
a datacenter controller configured to one of:
provision the virtual machine on the at least one working server; and
start up a new server and provision the virtual machine on the new server.

19. The datacenter of claim 18, wherein the scheduler is configured to determine the maximum co-run probability based on a number of virtual processing units available on the at least one working server.

20. The datacenter of claim 18, wherein the scheduler is configured to determine whether the virtual machine can be provisioned on the at least one working server based on an equal scheduling scheme.

21. The datacenter of claim 18, wherein the scheduler is further configured to:
determine at least one server type that satisfies both the maximum co-run probability and the computing resource capacity; and
determine whether the at least one working server has a configuration similar to the determined at least one server type.

22. The datacenter of claim 18, wherein the scheduler is further configured to evaluate at least one of an over-provisioning cost and a server launch cost to determine whether the virtual machine can be provisioned on the at least one working server.

23. The datacenter of claim 22, wherein the scheduler is configured to evaluate the over-provisioning cost and the server launch cost based on an estimated virtual machine start time and an estimated virtual machine time duration.

24. The datacenter of claim 23, wherein the scheduler is further configured to determine the estimated virtual machine start time and the estimated virtual machine time duration based on one or more of a linear regression estimation, a machine learning estimation, and a sliding window estimation.

25. The datacenter of claim 18, wherein the datacenter controller is configured to receive the security requirement for one or more instances of the virtual machine.
